(19) United States
(12) Patent Application Publication
(10) Pub. No.: US 2021/0150579 A1
(43) Pub. Date: May 20, 2021

(54) SYSTEM AND METHOD FOR ADVERTISING BY MEANS OF BACK OF CASH REGISTER PAPER

(71) Applicant: GUANGZHOU, ZONERICH BUSINESS MACHINE CO., LTD., Guangzhou (CN)

(72) Inventor: Liqiang LIU, Guangzhou (CN)

(21) Appl. No.: 16/627,635

(22) PCT Filed: Jul. 17, 2017
(86) PCT No.: PCT/CN2017/093082

§ 371 Date: Jan. 24, 2020

(30) Foreign Application Priority Data
Jun. 30, 2017 (CN) 201710519188.4

(51) Int. Cl. G06Q 30/02; G07G 5/00

(52) U.S. Cl. CPC G06Q 30/0268; G07G 5/00; G06Q 30/0277

(57) ABSTRACT

Disclosed are a system and a method for advertising by means of back of a cash register paper, the system includes a cloud advertisement server, at least one advertisement releasing terminal, and a plurality of duplex printers, the cloud advertisement server is wirelessly connected to the advertisement releasing terminal and the duplex printers respectively; the advertisement releasing terminal is configured for receiving advertisement contents input by a user, generating advertisement information, and sending advertisement information to the cloud advertisement server; the cloud advertisement server is configured for receiving the advertisement information sent by the advertisement releasing terminal, generating corresponding advertisement pushing information, and sending the advertisement pushing information to the duplex printers; and each of the duplex printers is configured for receiving the advertisement pushing information and printing corresponding advertisement information on back of a cash register paper while printing cash register information.

### FIELD

The disclosure relates to the field of information processing, and more particularly, to a system and method for advertising by means of back of a cash register paper.

### BACKGROUND

At present, generally speaking, back of a cash register paper is blank. In the prior art, if an advertisement needs to be printed on the back of the cash register paper, the advertisement is printed on the back of the cash register paper in advance after advertisement contents are customized by a customer, and then the cash register paper is put into a checkout counter for use. This method needs to collect the advertisement contents in advance, and then needs to perform a plurality of steps such as transportation, printing, cash register paper distribution and the like, which consumes more manpower and material resources and has a longer time period. Moreover, the advertisement contents printed by this method are fixed and cannot be changed after being printed on the back of the cash register paper, which is easy to cause invalid advertisements, spam advertisements and the like, the advertisement information has a poor timeliness, and cannot be updated in time or released as soon as possible.

### SUMMARY

In order to solve the technical problems above, the disclosure is intended to provide a system for advertising by means of back of a cash register paper, and the disclosure is further intended to provide a method for advertising by means of back of a cash register paper.

The technical solution adopted by the disclosure to solve the technical problems thereof is as follows.

There is provided a system for advertising by means of back of a cash register paper, including a cloud advertisement server, at least one advertisement releasing terminal, and a plurality of duplex printers, wherein the cloud advertisement server is wirelessly connected to the advertisement releasing terminal and the duplex printers respectively; the advertisement releasing terminal is configured for receiving advertisement contents input by a user, generating advertisement information, and sending advertisement information to the cloud advertisement server; the cloud advertisement server is configured for receiving the advertisement information sent by the advertisement releasing terminal, generating corresponding advertisement pushing information, and sending the advertisement pushing information to the duplex printers; and each of the duplex printers is configured for receiving the advertisement pushing information and printing corresponding advertisement information on back of a cash register paper while printing cash register information.

Further, the system includes a plurality of advertisement releasing terminals each having a priority level, and the advertisement releasing terminal with a high priority level has a priority to have an advertisement releasing permission, the cloud advertisement server pushes the advertisement information sent by the advertisement releasing terminals in sequence according to the priority levels, and the duplex printers print the corresponding advertisement information in sequence according to the priority levels.

Further, each of the advertisement releasing terminals maintains a real-time communication with the cloud advertisement server, and sends the advertisement information to be released to the cloud advertisement server in time after learning that the advertisement releasing terminal with a higher priority releases the advertisement releasing permission.

Further, the plurality of advertisement releasing terminals have progressive advertisement releasing permissions according to the priority levels thereof, and the plurality of duplex printers are grouped in multiple levels from small to large according to preset grouping conditions, the advertisement releasing terminal with higher priority level is configured to control the duplex printers in a smaller group, and the advertisement releasing terminal with lower priority level is configured to control the duplex printers in a larger group.

Further, the preset grouping conditions include grouping conditions according to preset regions or grouping conditions according to preset printing amounts.

Another technical solution adopted by the disclosure to solve the technical problems thereof is as follows.

There is provided a method for advertising by means of back of a cash register paper, including steps of:

receiving, by an advertisement releasing terminal, advertisement contents input by a user, generating advertisement information, and sending the advertisement information to a cloud advertisement server;

receiving, by the cloud advertisement server, the advertisement information sent by the advertisement releasing terminal, generating corresponding advertisement pushing information, and sending the advertisement pushing information to duplex printers; and receiving and analyzing, by the duplex printers, the advertisement pushing information, and printing corresponding advertisement information on back of a cash register paper while printing cash register information.

Further, the step of receiving, by the cloud advertisement server, the advertisement information sent by the advertisement releasing terminal, generating corresponding advertisement pushing information, and sending the advertisement pushing information to duplex printers includes:

receiving, by the cloud advertisement server, the advertisement information sent by the advertisement releasing terminal, generating corresponding advertisement pushing information, and sending the advertisement pushing information to the duplex printers corresponding to the advertisement releasing terminal according to a priority level of the advertisement releasing terminal when determining that the advertisement releasing terminal triggers an advertisement releasing permission thereof.

Further, the step of receiving and analyzing, by the duplex printers, the advertisement pushing information, and printing corresponding advertisement information on back of a cash register paper while printing cash register information includes:

receiving and analyzing, by the duplex printers, the advertisement pushing information, and generating advertisement information of corresponding format according to a dimension of the cash register paper; and

printing the corresponding advertisement information on the back of the cash register paper in real time while printing the cash register information.

Further, the step of printing the corresponding advertisement information on the back of the cash register paper in real time while printing the cash register information includes:

selecting corresponding advertisement information to be printed according to the priority level of the advertisement releasing terminal, and printing the corresponding advertisement information on the back of the cash register paper in real time while printing the cash register information.

Further, the step of printing the corresponding advertisement information on the back of the cash register paper in real time while printing the cash register information includes:

calculating a size of cash register paper occupied by the cash register information to be printed after obtaining the cash register information;

calculating a printing quantity of printable advertisement information according to the calculated size of the cash register paper occupied by the cash register information;

obtaining one or more corresponding advertisement information to be printed by combining the calculated printing quantity; and

printing the corresponding advertisement information on the back of the cash register paper in real time while printing the cash register information, including preferentially printing the advertisement information corresponding to the advertisement releasing terminal with a higher priority level, and printing the advertisement information corresponding to the advertisement releasing terminal with next priority level until all the advertisement information to be printed is printed.

The disclosure has the beneficial effects that: there is provided by the disclosure a system for advertising by means of back of a cash register paper, including a cloud advertisement server, at least one advertisement releasing terminal, and a plurality of duplex printers, wherein the cloud advertisement server is wirelessly connected to the advertisement releasing terminal and the duplex printers respectively; the advertisement releasing terminal is configured for receiving advertisement contents input by a user, generating advertisement information, and sending advertisement information to the cloud advertisement server; the cloud advertisement server is configured for receiving the advertisement information sent by the advertisement releasing terminal, generating corresponding advertisement pushing information, and sending the advertisement pushing information to the duplex printers; and each of the duplex printers is configured for receiving the advertisement pushing information and printing corresponding advertisement information on back of a cash register paper while printing cash register information. The system can timely send the advertisement information to be sent to the duplex printers for printing, can print various advertisement information without consuming a large amount of manpower and material resources for printing in advance, is relatively environment-friendly, can update or release the advertisement information at any time, is high in timeliness, and requirements of advertisement information pushing can be met.

The disclosure has another beneficial effect that: there is provided by the disclosure a method for advertising by means of back of a cash register paper, including steps of: receiving, by an advertisement releasing terminal, advertisement contents input by a user, generating advertisement information, and sending the advertisement information to a cloud advertisement server; receiving, by the cloud advertisement server, the advertisement information sent by the advertisement releasing terminal, generating corresponding advertisement pushing information, and sending the advertisement pushing information to duplex printers; and receiving and analyzing, by the duplex printers, the advertisement pushing information, and printing corresponding advertisement information on back of a cash register paper while printing cash register information. The method can timely send the advertisement information to be sent to the duplex printers for printing, can print various advertisement information without consuming a large amount of manpower and material resources for printing in advance, is relatively environment-friendly, can update or release the advertisement information at any time, is high in timeliness, and requirements of advertisement information pushing can be met.

### BRIEF DESCRIPTION OF THE DRAWINGS

The disclosure is further described hereinafter with reference to the drawings and the embodiments.

FIG. 1 is a structural block diagram of a system for advertising by means of back of a cash register paper according to the disclosure; and

FIG. 2 is a flow chart of a specific embodiment for advertising by means of back of a cash register paper according to the disclosure.

### DETAILED DESCRIPTION OF THE EMBODIMENTS

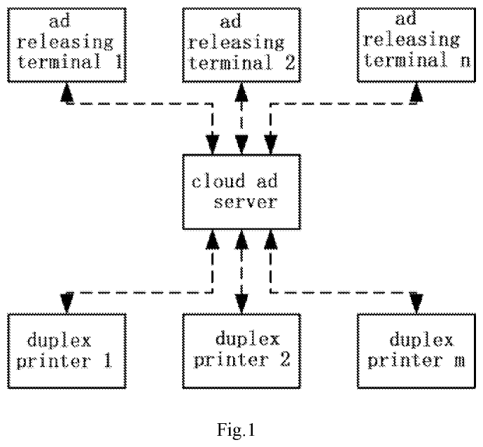

With reference to FIG. 1, the disclosure provides a system for advertising by means of back of a cash register paper, including a cloud advertisement server, at least one advertisement releasing terminal, and a plurality of duplex printers, wherein the cloud advertisement server is wirelessly connected to the advertisement releasing terminal and the duplex printers respectively; the advertisement releasing terminal is configured for receiving advertisement contents input by a user, generating advertisement information, and sending advertisement information to the cloud advertisement server; the cloud advertisement server is configured for receiving the advertisement information sent by the advertisement releasing terminal, generating corresponding advertisement pushing information, and sending the advertisement pushing information to the duplex printers; and each of the duplex printers is configured for receiving the advertisement pushing information and printing corresponding advertisement information on back of a cash register paper while printing cash register information.

As a further preferred embodiment, the system includes a plurality of advertisement releasing terminals each having a priority level, and the advertisement releasing terminal with a high priority level has a priority to have an advertisement releasing permission, the cloud advertisement server pushes the advertisement information sent by the advertisement releasing terminals in sequence according to the priority levels, and the duplex printers print the corresponding advertisement information in sequence according to the priority levels.

As a further preferred embodiment, each of the advertisement releasing terminals maintains a real-time communication with the cloud advertisement server, and sends the advertisement information to be released to the cloud advertisement server in time after learning that the advertisement releasing terminal with a higher priority releases the advertisement releasing permission.

As a further preferred embodiment, the plurality of advertisement releasing terminals have progressive advertisement releasing permissions according to the priority levels thereof, and the plurality of duplex printers are grouped in multiple levels from small to large according to preset grouping conditions, the advertisement releasing terminal with higher priority level is configured to control the duplex printers in a smaller group, and the advertisement releasing terminal with lower priority level is configured to control the duplex printers in a larger group.

As a further preferred embodiment, the preset grouping conditions include grouping conditions according to preset regions or grouping conditions according to preset printing amounts.

The disclosure further provides a method for advertising by means of back of a cash register paper, including steps of:

receiving, by an advertisement releasing terminal, advertisement contents input by a user, generating advertisement information, and sending the advertisement information to a cloud advertisement server;

receiving, by the cloud advertisement server, the advertisement information sent by the advertisement releasing terminal, generating corresponding advertisement pushing information, and sending the advertisement pushing information to duplex printers; and receiving and analyzing, by the duplex printers, the advertisement pushing information, and printing corresponding advertisement information on back of a cash register paper while printing cash register information.

As a further preferred embodiment, the step of receiving, by the cloud advertisement server, the advertisement information sent by the advertisement releasing terminal, generating corresponding advertisement pushing information, and sending the advertisement pushing information to duplex printers includes:

receiving, by the cloud advertisement server, the advertisement information sent by the advertisement releasing terminal, generating corresponding advertisement pushing information, and sending the advertisement pushing information to the duplex printers corresponding to the advertisement releasing terminal according to a priority level of the advertisement releasing terminal when determining that the advertisement releasing terminal triggers an advertisement releasing permission thereof.

As a further preferred embodiment, the step of receiving and analyzing, by the duplex printers, the advertisement pushing information, and printing corresponding advertisement information on back of a cash register paper while printing cash register information includes:

receiving and analyzing, by the duplex printers, the advertisement pushing information, and generating advertisement information of corresponding format according to a dimension of the cash register paper; and printing the corresponding advertisement information on the back of the cash register paper in real time while printing the cash register information.

As a further preferred embodiment, the step of printing the corresponding advertisement information on the back of the cash register paper in real time while printing the cash register information includes:

selecting corresponding advertisement information to be printed according to the priority level of the advertisement releasing terminal, and printing the corresponding advertisement information on the back of the cash register paper in real time while printing the cash register information.

As a further preferred embodiment, the step of printing the corresponding advertisement information on the back of the cash register paper in real time while printing the cash register information includes:

calculating a size of cash register paper occupied by the cash register information to be printed after obtaining the cash register information;

calculating a printing quantity of printable advertisement information according to the calculated size of the cash register paper occupied by the cash register information;

obtaining one or more corresponding advertisement information to be printed by combining the calculated printing quantity; and

printing the corresponding advertisement information on the back of the cash register paper in real time while printing the cash register information, including preferentially printing the advertisement information corresponding to the advertisement releasing terminal with a higher priority level, and printing the advertisement information corresponding to the advertisement releasing terminal with next priority level until all the advertisement information to be printed is printed.

The disclosure is described in detail hereinafter with reference to more specific embodiments.

With reference to FIG. 1, a system for advertising by means of back of a cash register paper includes a cloud advertisement server, a plurality of advertisement releasing terminals, and a plurality of duplex printers. The cloud advertisement server is wirelessly connected to the advertisement releasing terminals and the duplex printers respectively. Each of the advertisement releasing terminals is configured for receiving advertisement contents input by a user, generating advertisement information, and sending the advertisement information to the cloud advertisement server. The cloud advertisement server is configured for receiving the advertisement information sent by the advertisement releasing terminal, generating corresponding advertisement pushing information, and sending the corresponding advertisement pushing information to the duplex printers. Each of the duplex printers is configured for receiving the advertisement pushing information and printing corresponding advertisement information on the back of the cash register paper while printing cash register information. FIG. 1 shows an advertisement releasing terminal 1 to an advertisement releasing terminal n as well as a duplex printer 1 to a duplex printer m, wherein n is a positive integer greater than or equal to 1, and m is a positive integer greater than or equal to 2.

In this embodiment, there is provided with a plurality of advertisement releasing terminals each with a priority level, the advertisement releasing terminal with a high priority level has a priority to have an advertisement releasing permission, the cloud advertisement server pushes the advertisement information sent by the advertisement releasing terminals in sequence according to the priority levels, and the duplex printers print the corresponding advertisement information in sequence according to the priority levels. The priority levels may be referred to as, from high to low, first priority level, second priority level until the lowest priority level. When the cloud advertisement server performs the advertisement information pushing, the advertisement information sent by the advertisement releasing terminal with a higher priority level is preferentially pushed. The duplex printers may print the advertisement information in various manners. For example, if only one piece of advertisement information is printed, the advertisement information sent by the advertisement releasing terminal with the highest priority level will be printed. If a plurality of advertisement information can be printed, each advertisement information can be printed in sequence according to the priority levels, and the amounts of advertisement information to be printed may be determined according to the size of the cash register paper. The advertisement information includes various advertisement contents, and may also be various pieces of coupon information.

In this embodiment, each of the advertisement releasing terminals maintains a real-time communication with the cloud advertisement server, and send the advertisement information to be released to the cloud advertisement server in time after learning that the advertisement releasing terminal with a higher priority releases the advertisement releasing permission. There are many situations for the advertisement releasing terminal to release the advertisement releasing permission. For example, the advertisement releasing terminal sends a corresponding notification representing completion of sending the advertisement information, or automatically identifying that the advertisement releasing terminal releases the advertisement releasing permission after the advertisement releasing terminal finishes sending the advertisement information, or sets an occupation time of the advertisement releasing permission thereof. In short, each of the advertisement releasing terminals performs real-time detection, and can send advertisement information to the cloud advertisement server as long as it is detected to be idle.

The advertisement releasing terminals may be specially configured computers, or mobile phones with a corresponding permission, or an APPs with an advertisement information releasing function. In the disclosure, the advertisement releasing terminals mainly play a role of an information releasing interface. Advertisement information, when released by a user, may be sent to an advertisement releasing terminal through various intelligent terminals, edited by an operator of the advertisement releasing terminal, and then sent to the cloud advertisement server.

Therefore, a plurality of advertisement releasing terminals have progressive advertisement releasing permissions according to the priority levels thereof. In this embodiment, the plurality of duplex printers are grouped in multiple levels from small to large according to preset grouping conditions, the advertisement releasing terminal with a higher priority level is configured to control the duplex printers in a smaller group, and the advertisement releasing terminal with a lower priority level is configured to control the duplex printers in a larger group. The preset grouping conditions include grouping conditions according to preset regions or grouping conditions according to preset printing amounts. For example, grouping is performed according to preset regions, respectively corresponding to four regions such as a housing estate, a street, a district and a city. Based on the pertinence of advertisement information pushing, the grouping of the duplex printers controlled by the advertisement releasing terminal with a first priority level is set to be housing estate grouping, the advertisement releasing terminal with a second priority level correspondingly controls street grouping, the advertisement releasing terminal with a third priority level correspondingly controls district grouping, and the advertisement releasing terminal with a fourth priority level, i.e., the lowest priority level, correspondingly controls city grouping. Therefore, according to the progressive advertisement releasing permissions, the advertisement releasing terminals with different priority levels can control the grouping of the duplex printers within different ranges, thus performing advertisement releasing printing. For example, an advertisement releasing terminal a with the first priority level controls the duplex printers in the corresponding housing estate to print advertisement information A. During idle time of printing, i.e., when the advertisement information released by the advertisement releasing terminal a has been printed or is temporarily not printed, an advertisement releasing terminal b with the second priority level controls the duplex printers in the corresponding street to print the advertisement information B, and so on. In addition, as previously mentioned, the duplex printers may print the advertisement information A first and then continue to print the advertisement information B if there remains a position on the back of the cash register paper.

As long as the duplex printers are configured in advance at various charging terminals, such as convenience stores, shops, supermarkets and the like, and wireless communications are established between the duplex printers and the cloud advertisement server, advertisement information can be sent to the duplex printers for printing, and various advertisement information can be printed without consuming a large amount of manpower and material resources for printing in advance, the advertisement information can be updated or released at any time, which is high in timeliness and can meet the requirements of advertisement information pushing. Moreover, the method is relatively environment-friendly without consuming additional materials. In addition, the method can also realize targeted advertisement information releasing, for example, when printing advertisement information aiming at a certain housing estate on cash register papers of various cash register terminals in the housing estate, it is only necessary to send the corresponding advertisement information to the cloud advertisement server through the advertisement releasing terminal.

Correspondingly, a method for advertising based on the embodiment is as follows.

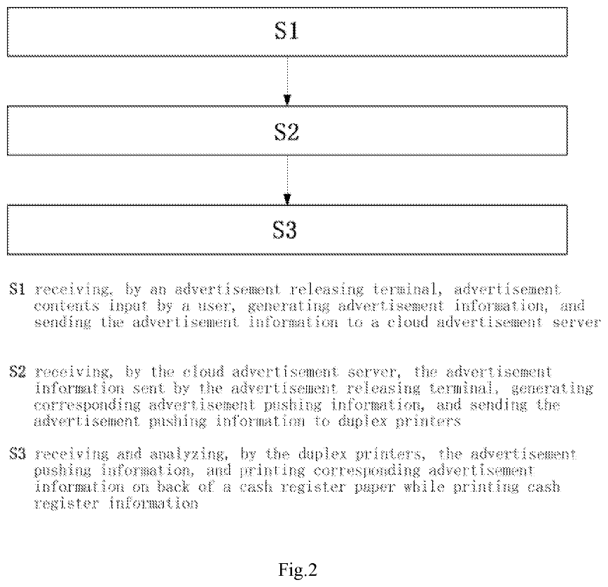

With reference to FIG. 2, there is provided a method for advertising by means of back of cash register paper including the steps of:

S1. receiving, by an advertisement releasing terminal, advertisement contents input by a user, generating advertisement information, and sending the advertisement information to a cloud advertisement server;

S2. receiving, by the cloud advertisement server, the advertisement information sent by the advertisement releasing terminal, generating corresponding advertisement pushing information, and sending the advertisement pushing information to duplex printers; and

S3. receiving and analyzing, by the duplex printers, the advertisement pushing information, and printing corresponding advertisement information on back of a cash register paper while printing cash register information.

The step S2 particularly includes:

receiving, by the cloud advertisement server, the advertisement information sent by the advertisement releasing terminal, generating corresponding advertisement pushing information, and sending the advertisement pushing information to the duplex printers corresponding to the advertisement releasing terminal according to a priority level of the advertisement releasing terminal when determining that the advertisement releasing terminal triggers an advertisement releasing permission thereof.

The step S3 includes:

S31. receiving and analyzing, by the duplex printers, the advertisement pushing information, and generating advertisement information of corresponding format according to a dimension of the cash register paper; and

S32. printing the corresponding advertisement information on the back of the cash register paper in real time while printing the cash register information.

According to a first embodiment, the step S32 includes: selecting corresponding advertisement information to be printed according to priority level of the advertisement releasing terminal, and printing the corresponding advertisement information on the back of the cash register paper in real time while printing the cash register information.

According to a second embodiment, the step S32 includes the steps of: S321. calculating a size of cash register paper occupied by the cash register information to be printed after obtaining the cash register information;

S322. calculating a printing quantity of printable advertisement information according to the calculated size of the cash register paper occupied by the cash register information;

S323. obtaining one or more corresponding advertisement information to be printed by combining the calculated printing quantity; and

S324. printing the corresponding advertisement information on the back of the cash register paper in real time while printing the cash register information, including preferentially printing the advertisement information corresponding to the advertisement releasing terminal with a higher priority level, and printing the advertisement information corresponding to the advertisement releasing terminal with next priority level until all the advertisement information to be printed is printed.

Therefore, according to the disclosure, by adopting the cloud advertisement server, the advertisement releasing terminal and the plurality of duplex printers, the advertisement information to be sent can be timely sent via communication networks to the duplex printers for printing, various advertisement information can be printed without consuming a large amount of manpower and material resources for printing in advance, the advertisement information can be updated or released at any time, which is high in timeliness and can meet requirements of advertisement information pushing.

The foregoing describes the preferred embodiments of the disclosure in detail, but the disclosure is not limited to the embodiments. Those skilled in the art can also make various equivalent modifications or substitutions without departing from the concept of the disclosure, and these equivalent modifications or substitutions shall all fall within the scope defined by the claims of the disclosure.

1. A system for advertising by means of back of a cash register paper, comprising a cloud advertisement server, at least one advertisement releasing terminal, and a plurality of duplex printers, wherein the cloud advertisement server is wirelessly connected to the advertisement releasing terminal and the duplex printers respectively; the advertisement releasing terminal is configured for receiving advertisement contents input by a user, generating advertisement information, and sending advertisement information to the cloud advertisement server; the cloud advertisement server is configured for receiving the advertisement information sent by the advertisement releasing terminal, generating corresponding advertisement pushing information, and sending the advertisement pushing information to the duplex printers; and each of the duplex printers is configured for receiving the advertisement pushing information and printing corresponding advertisement information on back of a cash register paper while printing cash register information.

2. The system for advertising by means of back of a cash register paper of claim 1, wherein the system comprises a plurality of advertisement releasing terminals each having a priority level, and the advertisement releasing terminal with a high priority level has a priority to have an advertisement releasing permission, the cloud advertisement server pushes the advertisement information sent by the advertisement releasing terminals in sequence according to the priority levels, and the duplex printers print the corresponding advertisement information in sequence according to the priority levels.

3. The system for advertising by means of back of a cash register paper of claim 2, wherein each of the advertisement releasing terminals maintains a real-time communication with the cloud advertisement server, and sends the advertisement information to be released to the cloud advertisement server in time after learning that the advertisement releasing terminal with a higher priority releases the advertisement releasing permission.

4. The system for advertising by means of back of a cash register paper of claim 3, wherein the plurality of advertisement releasing terminals have progressive advertisement releasing permissions according to the priority levels thereof, and the plurality of duplex printers are grouped in multiple levels from small to large according to preset grouping conditions, the advertisement releasing terminal with higher priority level is configured to control the duplex printers in a smaller group, and the advertisement releasing terminal with lower priority level is configured to control the duplex printers in a larger group.

5. The system for advertising by means of back of a cash register paper of claim 4, wherein the preset grouping conditions comprise grouping conditions according to preset regions or grouping conditions according to preset printing amounts.

6. A method for advertising by means of back of a cash register paper, comprising steps of:
receiving, by an advertisement releasing terminal, advertisement contents input by a user, generating advertisement information, and sending the advertisement information to a cloud advertisement server;
receiving, by the cloud advertisement server, the advertisement information sent by the advertisement releasing terminal, generating corresponding advertisement pushing information, and sending the advertisement pushing information to duplex printers; and
receiving and analyzing, by the duplex printers, the advertisement pushing information, and printing corresponding advertisement information on back of a cash register paper while printing cash register information.

7. The method for advertising by means of back of a cash register paper of claim 6, wherein the step of receiving, by the cloud advertisement server, the advertisement information sent by the advertisement releasing terminal, generating corresponding advertisement pushing information, and sending the advertisement pushing information to duplex printers comprises:
receiving, by the cloud advertisement server, the advertisement information sent by the advertisement releasing terminal, generating corresponding advertisement pushing information, and sending the advertisement pushing information to the duplex printers corresponding to the advertisement releasing terminal according to a priority level of the advertisement releasing terminal when determining that the advertisement releasing terminal triggers an advertisement releasing permission thereof.

8. The method for advertising by means of back of a cash register paper of claim 7, wherein the step of receiving and analyzing, by the duplex printers, the advertisement pushing information, and printing corresponding advertisement information on back of a cash register paper while printing cash register information comprises:
receiving and analyzing, by the duplex printers, the advertisement pushing information, and generating advertisement information of corresponding format according to a dimension of the cash register paper; and
printing the corresponding advertisement information on the back of the cash register paper in real time while printing the cash register information.

9. The method for advertising by means of back of a cash register paper of claim 8, wherein the step of printing the corresponding advertisement information on the back of the cash register paper in real time while printing the cash register information comprises:
selecting corresponding advertisement information to be printed according to the priority level of the advertisement releasing terminal, and printing the corresponding advertisement information on the back of the cash register paper in real time while printing the cash register information.

10. The method for advertising by means of back of a cash register paper of claim 8, wherein the step of printing the corresponding advertisement information on the back of the cash register paper in real time while printing the cash register information comprises:
calculating a size of cash register paper occupied by the cash register information to be printed after obtaining the cash register information;
calculating a printing quantity of printable advertisement information according to the calculated size of the cash register paper occupied by the cash register information;
obtaining one or more corresponding advertisement information to be printed by combining the calculated printing quantity; and
printing the corresponding advertisement information on the back of the cash register paper in real time while printing the cash register information, including preferentially printing the advertisement information corresponding to the advertisement releasing terminal with a higher priority level, and printing the advertisement information corresponding to the advertisement releasing terminal with next priority level until all the advertisement information to be printed is printed.
